(19) United States
(12) Patent Application Publication
(10) Pub. No.: US 2008/0072011 A1
(43) Pub. Date: Mar. 20, 2008

(54) SIMD type microprocessor

(76) Inventor: Hidehito Kitamura, Osaka (JP)

Correspondence Address: DICKSTEIN SHAPIRO LLP, 1825 EYE STREET NW, Washington, DC, 20006-5403, US

(21) Appl. No.: 11/898,292

(22) Filed: Sep. 11, 2007

(30) Foreign Application Priority Data
Sep. 14, 2006 (JP) 2006-249375

(51) Int. Cl. G06F 15/80; G06F 9/02

(52) U.S. Cl. 712/22; 712/E09.002

(57) ABSTRACT

A SIMD type microprocessor that has two or more processor elements (PEs), and two or more computing units for every processor element (PE) is disclosed. According to the SIMD type microprocessor, each PE includes M arithmetic logic-operation circuits (M is a natural number 2 or greater), M registers for storing operation results corresponding to the arithmetic logic-operation circuits, and M condition registers for storing condition data output by the arithmetic logic-operation circuits. When a conditional command is issued, each arithmetic logic-operation circuit determines whether to perform a requested operation based on the condition data stored in the corresponding condition register.

### BACKGROUND OF THE INVENTION

1. Field of the Invention

The present invention relates to a SIMD (Single Instruction Multiple Data) type microprocessor wherein two or more sets of image data, and the like, are processed in parallel by a single operations command, which may be a conditional command.

2. Description of the Related Art

SIMD type microprocessors are often used for image processing because a feature of the SIMD type microprocessors is suitable for image processing. The feature is that the same operational process is simultaneously carried out on two or more sets of data by a single command. The SIMD type microprocessor includes two or more processor elements (PEs), and each PE includes a computing unit and a register. The same operational process is simultaneously performed on the sets of data by a single command with the PEs simultaneously performing the same operational process. If the SIMD type microprocessor is used, the processing speed can be improved, and a command feeder and a command control device can be shared.

A SIMD type microprocessor 8 (refer to FIG. 3) includes a global processor 2 and a processor element array 6. The processor element array 6 includes two or more processor elements (PEs) 4. Each PE 4 includes a computing unit (arithmetic logic operation circuit) and a register file unit. The global processor 2 is an independent processor for reading and executing a program, and for controlling operations of each PE 4 by issuing directions. The global processor 2 includes a controlling circuit, a Program-RAM for storing the program, a Data-RAM for temporarily storing data, and various registers (not illustrated).

As described above, according to the SIMD type microprocessor, the PEs perform the same operational process on separate sets of data. In other words, different processes by different PEs cannot be carried out. For example, the SIMD type microprocessor is not good at comparing a set of data with another set of data, and replacing agreed data with “0” depending on the result of the comparison. If a conditional command, such as above, can be executed, the processing speed will be improved. Further, if a great number of conditions can be stored for the conditional command, the choice of processes will be expanded and the processing speed will be improved.

Further, according to the SIMD type microprocessor, one computing unit (arithmetic logic-operation circuit) is usually provided per PE. Then, depending on the size of operational data, the circuit scale may need to have an irrational magnitude. For example, if operations of 16-bit data are usually performed, and operations of 32-bit data are required once in a while, however rarely, each PE must include a computing unit capable of processing the greatest data width. That is, the circuit and the microprocessor are not efficiently used.

Patent Reference 1 discloses an operational processing apparatus that carries out parallel processing of two or more data sets by one command, wherein

a write enable signal for controlling whether an operational result is written in the register for storing operational results is generated based on an operation flag,

a mask process according to an operational result of two or more computing units is performed without executing a conditional command, and

the processing speed is improved. However, there is no disclosure about the conditional command, and it does not have the concept of a processor element, either.

Patent Reference 2 discloses an operational processing apparatus that carries out parallel processing of two or more sets of data by one command. The apparatus includes an operation flag controlling circuit for every operations unit so that a conditional operation of the operations units is made possible by one command, and the processing speed is increased. Further, the conditional processing is made possible without going through a command supply circuit. In this way, the processing speed is increased compared with the approach using a conditional command. However, there is no concept of a processor element.

Patent Reference 3 discloses an operational processing apparatus that carries out parallel processing of two or more sets of data by one command, wherein computing units are either integrated or split according to the magnitude of operational data, and conditional execution of a command is enabled. In this way, the processing speed is increased. However, there is no concept of a processor element.

Patent Reference 4 discloses an operational processing apparatus that carries out parallel processing of two or more sets of data by one command, wherein each PE includes a computing unit, a flag information storage, and a data selection unit. According to the apparatus, the number of processing steps is reduced by selecting a set of data depending on a result of a conditional command by one instruction code. However, there is no disclosure about processing the data by processor elements.

Patent Reference 5 discloses a processor that is capable of high-speed operations, wherein data are divided into two or more sets as directed by an operand, and a conditional command is carried out only by a set that meets the condition. According to this processor, it is independently possible to verify conditions even if the operand data are one set of data, which increases flexibility of a program. However, there is no concept of a processor element.

[Patent reference 1] JP 2806346

[Patent reference 2] JPA H5-189585

[Patent reference 3] JP 3652518

[Patent reference 4] JPA 2004-334297

[Patent reference 5] JPA 2001-265592

[Disclosure of Invention]

[Objective of Invention]

As described above, where every PE of the conventional SIMD type microprocessor includes two or more computing units (arithmetic logic-operation circuit), it does not have a function of determining whether calculation is to be carried out by each computing unit (arithmetic logic-operation circuit) in the case of a conditional command.

### SUMMARY OF THE INVENTION

The present invention provides a SIMD type microprocessor that substantially obviates one or more of the problems caused by the limitations and disadvantages of the related art.

Features of embodiments of the present invention are set forth in the description that follows, and in part will become apparent from the description and the accompanying drawings, or may be learned by practice of the invention according to the teachings provided in the description. Problem solutions provided by an embodiment of the present invention may be realized and attained by a SIMD type microprocessor particularly pointed out in the specification in such full, clear, concise, and exact terms as to enable a person having ordinary skill in the art to practice the invention.

To achieve these solutions and in accordance with an aspect of the invention, as embodied and broadly described herein, an embodiment of the invention provides a SIMD type microprocessor as follows.

The SIMD type microprocessor according to the embodiment of the present invention includes processor elements PEs. Each PE includes two or more computing units (arithmetic logic-operation circuits) that include registers such that each computing unit (arithmetic logic-operation circuit) may determine based on the condition data whether to perform an operation when a conditional command is subsequently received. In this way, the processing speed is increased.

Further, when the operational data size is great, the computing units (arithmetic logic-operation circuit) of each PE are integrated, and determine, based on the condition data, whether to perform an operation when a conditional command is subsequently received. In this way, the circuit is efficiently used. Furthermore, in this way, the number of bits available for condition data can be increased, which increases the number of conditions for processing the conditional command. In this way, the processing speed is increased.

[Means for Solving a Problem]

According to an aspect of the embodiment of the present invention, the SIMD type microprocessor that includes two or more processor elements constituting a processor element array, each processor element including M arithmetic logic-operation circuits (M is a natural number 2 or greater), and M registers for storing operation results of the corresponding arithmetic logic-operation circuits further includes M condition registers for each processor element to store condition data that are output by each arithmetic logic-operation circuit, wherein each of the arithmetic logic-operation circuits determines whether to perform an operation based on the condition data when a conditional command is subsequently received.

According to the SIMD type microprocessor of another aspect of the embodiment, each processor element includes an integrating unit for bundling N arithmetic logic-operation circuits (2<=N<=M). When the N arithmetic logic-operation circuits are integrated by the integrating unit, sets of condition data generated by the N arithmetic logic-operation circuits are integrated into one set. The set is stored in one of N condition registers corresponding to the N arithmetic logic-operation circuits. The integrated arithmetic logic-operation circuits determine based on the condition data whether to perform an operation when a conditional command is subsequently received.

According to the SIMD type microprocessor of another aspect of the embodiment, when each processor element integrates the N arithmetic logic-operation circuits (2<=N<=M) for processing, the N condition registers are integrated such that the number of bits available for storing the condition data is expanded by N times.

[Effectiveness of Invention]

As described above, according to the embodiment of the present invention, the SIMD type microprocessor including a great number of PEs, each PE including two or more computing units (arithmetic logic-operation circuit), and each computing unit (arithmetic logic-operation circuit) determines whether to perform an operation based on the condition data when a conditional command is subsequently received; in this way, the processing speed is increased. Further, if the magnitude of data to be handled is great, the SIMD type microprocessor is capable of dynamically coping with the situation. Furthermore, the number of bits of the condition data in the case of executing a conditional command is increased.

### BRIEF DESCRIPTION OF THE DRAWINGS

FIG. 1 is a block diagram of a part of a PE (processor element) of a SIMD type microprocessor according to Embodiment 1 of the present invention;

FIG. 2 is a block diagram of a part of the PE (processor element) of the SIMD type microprocessor according to Embodiment 2 of the present invention;

FIG. 3 is a block diagram of a part of the SIMD type microprocessor according to Embodiment 3 of the present invention;

FIG. 4 is a block diagram of a part of the PE (processor element) of the SIMD type microprocessor according to Embodiment 4 of the present invention;

FIG. 5 is a block diagram of a part of the PE (processor element) of the SIMD type microprocessor according to Embodiment 5 of the present invention;

FIG. 6 is a block diagram of a part of the PE (processor element) of the SIMD type microprocessor according to Embodiment 6 of the present invention;

FIG. 7 is a block diagram of a part of the PE (processor element) of the SIMD type microprocessor according to Embodiment 7 of the present invention;

FIG. 8 is a block diagram of a part of the PE (processor element) of the SIMD type microprocessor according to Embodiment 8 of the present invention;

FIG. 9 is a block diagram of a part of the PE (processor element) of the SIMD type microprocessor according to Embodiment 9 of the present invention;

FIG. 10 is a block diagram of a part of the PE (processor element) of the SIMD type microprocessor according to Embodiment 10 of the present invention;

FIG. 11 is a circuit diagram of a flag integrating unit; and

FIG. 12 is a block diagram of condition registers, specifically condition register 1 and condition register 2.

### DESCRIPTION OF THE PREFERRED EMBODIMENTS

In the following, embodiments of the present invention are described with reference to the accompanying drawings.

### Embodiment 1

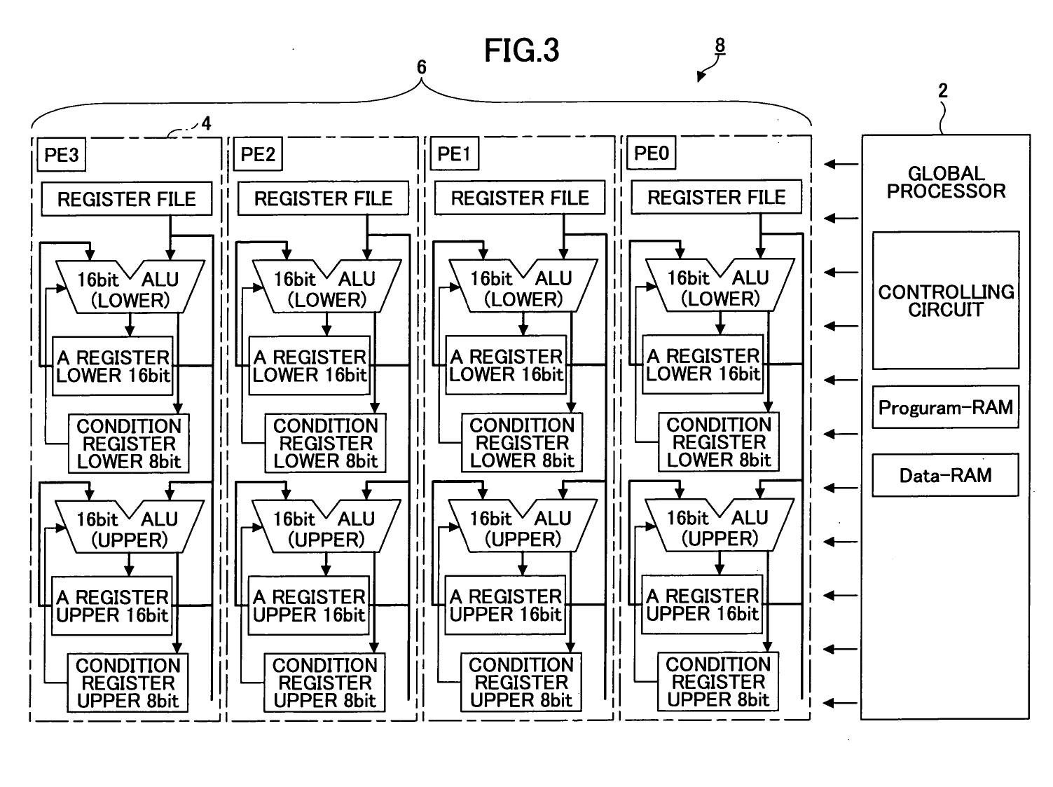

A SIMD type microprocessor 8 (ref. FIG. 3) according to Embodiment 1 of the present invention includes a PE (processor element) array 6 that includes two or more PEs 4, wherein each PE 4 includes M arithmetic logic-operation circuits (M is a natural number 2 or greater), and M registers for storing operational results. This configuration is common to Embodiments 2 and 3.

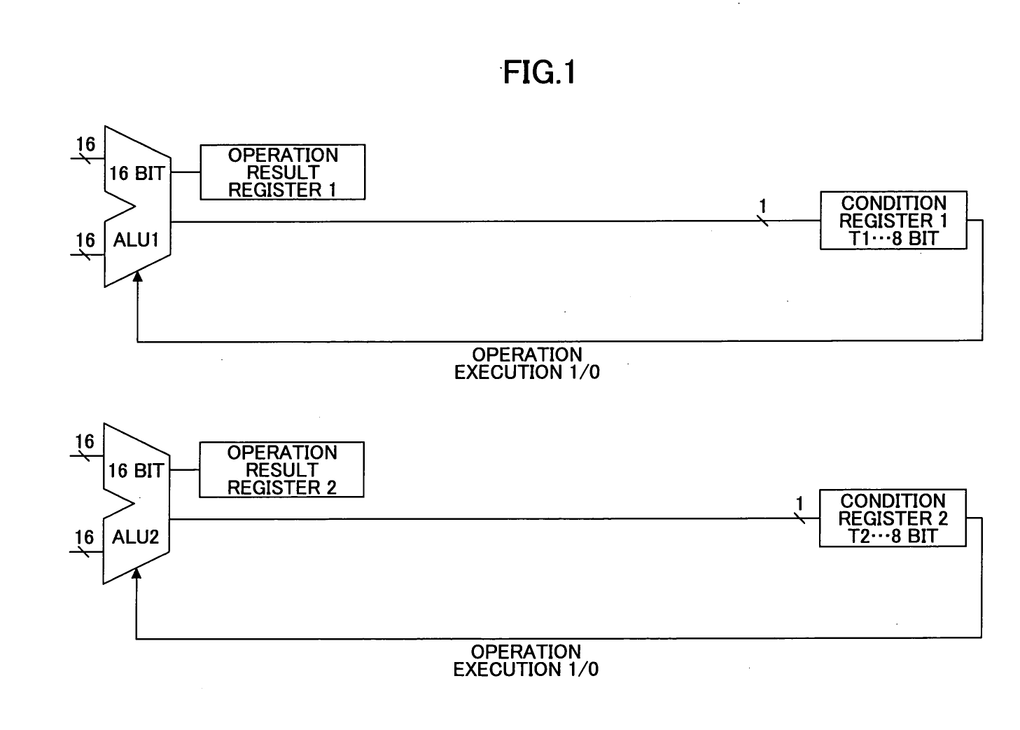

FIG. 1 shows a part of the PE 4 of the SIMD type microprocessor 8 according to Embodiment 1 of the present invention. The PE includes two arithmetic logic-operation circuits (ALU1 and ALU2), two registers for storing operational results (operation result register 1 and operation result register 2), and two condition registers (condition register 1 and condition register 2).

The arithmetic logic-operation circuits (ALU1 and ALU2) receive a 16-bit data input, and operate based on a control signal provided by an external apparatus. The registers for storing operational results (the operation result register 1 and the operation result register 2) are for 16-bits, and store the operational result data of the corresponding arithmetic logic-operation circuits.

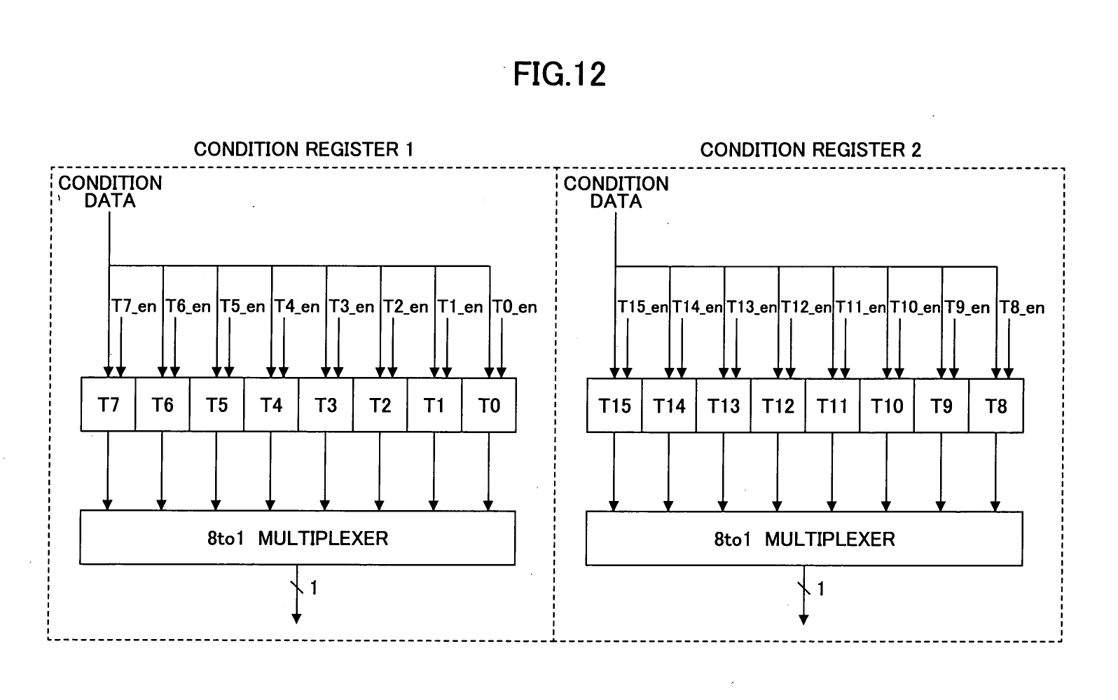

FIG. 12 is a block diagram showing the condition registers (the condition register 1 and the condition register 2). Both condition register 1 and condition register 2 are configured the same, and each includes 8 partial registers (each register is capable of 1 bit). The partial registers of the condition register 1 are called T0 through T7; and the partial registers of the condition register 2 are called T8 through T15. The condition register receives one bit of condition data as an input. Write enable signals T0_en through T7_en are provided to the partial registers T0 through T7, respectively. Write enable signals T8_en through T15_en are provided to the partial registers T8 through T15, respectively. The condition data are stored in either of T0 through T7 and T8 through T15 of the condition registers.

A bit is selected out of the 8 bits of T0 through T7, and a bit is selected out of the 8 bits of T8 through T15; then the selected bits are output. The condition data stored in the T0 through T7 and T8 through T15 directly determine whether to perform an operation when a conditional command is subsequently received. As described, each of the condition registers stores 8 conditions.

According to the PE of Embodiment 1, when processing two sets of 16-bit data, the condition data output by the arithmetic logic-operation circuits (ALU1 and ALU2) are directly provided to the condition registers (the condition register 1 and the condition register 2). The condition data are provided to ALU1 and ALU2 by the condition register 1 and the condition register 2, respectively. Whether an operation of a conditional command that is subsequently received is to be carried out is determined based on the condition data.

### Embodiment 2

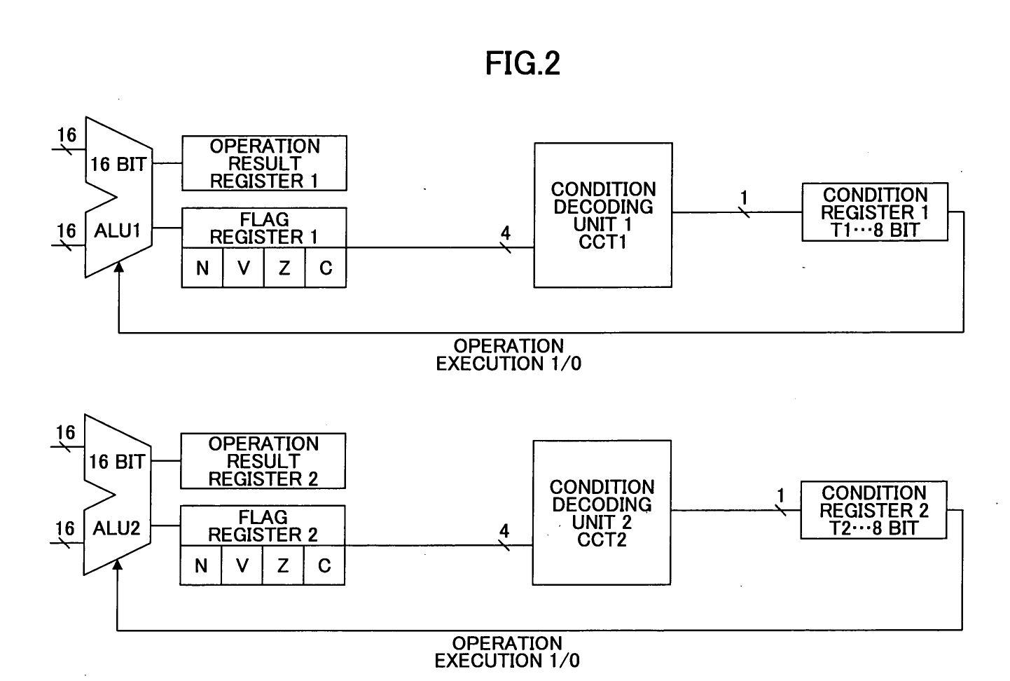

FIG. 2 shows a part of the PE (processor element) 4 of the SIMD type microprocessor 8 according to Embodiment 2 of the present invention. The PE includes two flag register groups (flag register group 1 and flag register group 2), and two condition decoding units (CCT1 and CCT2) in addition to the functional units described in Embodiment 1, namely, the arithmetic logic-operation circuits (ALU1 and ALU2), the registers for storing the operation result (the operation result register 1 and the operation result register 2), and the condition registers (the condition register 1 and the condition register 2).

The flag register groups (the flag register group 1 and the flag register group 2) are capable of handling 4 bits, and hold flag data. Here, the flag data are provided by the arithmetic logic-operation circuits (ALU1 and ALU2), and include

N: Code flag

V: Overflow flag

Z: Zero flag

C: Carry flag

The condition decoding units (CCT1 and CCT2) receive the flag data as an input, and generate 1 bit of condition data of a conditional command that follows. For example, the condition data to be generated may be an exclusive OR of N and V of the flag data, or alternatively a reversal of C.

In the PE 4 according to Embodiment 2, when processing two sets of 16-bit data, the condition data output by the condition decoding units (CCT1 and CCT2) are directly stored in the condition registers (the condition register 1 and the condition register 2). The condition data are provided by the condition register 1 and the condition register 2 to the ALU1 and ALU2, respectively. Whether operational execution of a conditional command is to be carried out is determined based on the condition data.

According to the SIMD type microprocessor of Embodiment 2, when it is impossible to store the condition data from the arithmetic logic-operation circuit in the condition register in 1 cycle, it is possible to hold flag data or condition data in the flag register group (the flag register group 1 and the flag register group 2) once, and to provide them to the condition registers (the condition register 1 and the condition register 2) in the following cycle.

Furthermore, a great number of sets of complicated condition data can be generated by the condition decoding units (CCT1 and CCT2) so that the processing speed may be increased.

### Embodiment 3

FIG. 3 shows a part of the SIMD type microprocessor 8 according to Embodiment 3 of the present invention. Here, four PEs 4 (PE0 through PE3) are illustrated. Each PE includes two arithmetic logic-operation circuits (a lower-bit ALU and a higher-bit ALU), two registers for storing operation results (a lower-bit A register and a higher-bit A register), and two condition registers (a lower-bit condition register and a higher-bit condition register).

A global processor 2 provides a control signal to the PEs 4. Each PE 4 carries out an operation corresponding to a conditional command with the two computing units (arithmetic logic-operation circuits).

In the following Embodiments, the configuration of one PE is described, since all the PEs within an Embodiment are configured the same.

### Embodiment 4

The SIMD type microprocessor 8 according to Embodiments 4 and 5 includes a PE array that includes two or more PEs. Each PE includes M (M is a natural number 2 or greater) arithmetic logic-operation circuits, and M registers for storing operational results. Furthermore, the PE includes an integrating unit for integrating N (2<=N<=M) computing units (arithmetic logic-operation circuits) for processing.

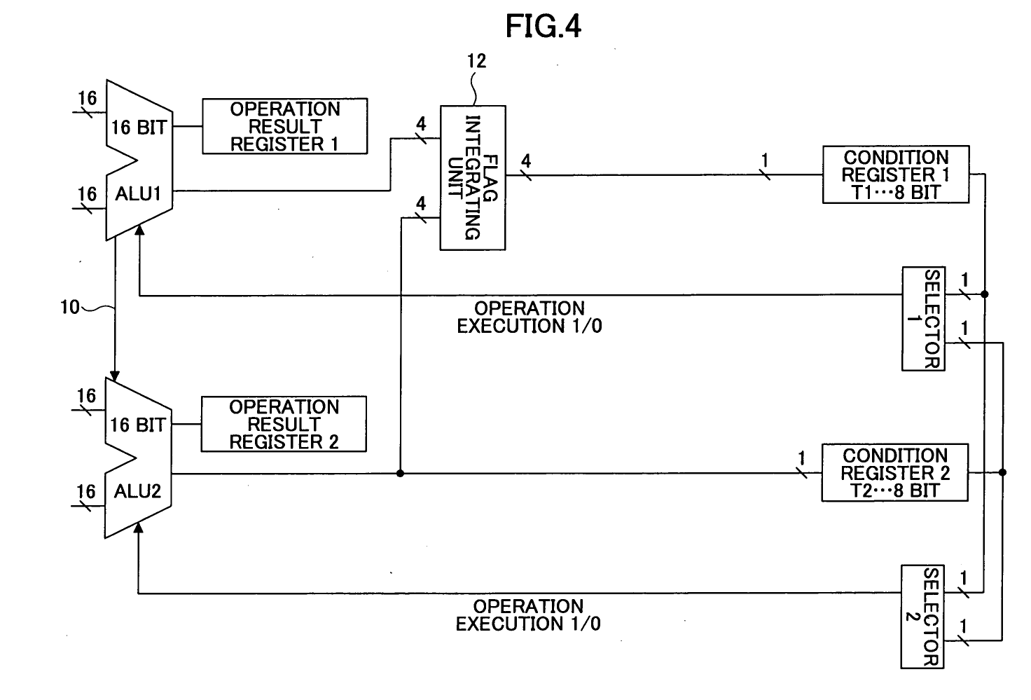

FIG. 4 is a block diagram of a part of the PE (processor element) 4 of the SIMD type microprocessor 8 according to Embodiment 4 of the present invention. The PE includes two arithmetic logic-operation circuits (ALU1 and ALU2), two registers for storing operational results (the operation result register 1 and the operation result register 2), and two condition registers (the condition register 1 and the condition register 2), which configuration is the same as Embodiment 1.

Furthermore, according to Embodiment 4, the PE includes an integrating unit 12 for integrating two computing units (arithmetic logic-operation circuits) for processing. That is, the PE includes the integrating unit 12, two selectors (a selector 1 and a selector 2), and a path 10 between ALU1 and ALU2 for propagating a carry from ALU1 to ALU2.

The arithmetic logic-operation circuits (ALU1 and ALU2) carry out an operation on 16-bit data that are input with a control signal from an external apparatus. The registers for storing operational results (the operation result register 1 and the operation result register 2) are capable of 16 bits, and are for storing operation results of the corresponding arithmetic logic-operation circuits. The integrating unit 12 is for selecting condition data provided by the arithmetic logic-operation circuits (ALU1 and ALU2). Selectors (a selector 1 and selector 2) are for selecting condition data provided by the condition register 1 and the condition register 2, and providing the selected condition data to the arithmetic logic-operation circuits (ALU1 and ALU2), respectively.

The path 10 is activated when the computing units (arithmetic logic-operation circuits (ALU1 and ALU2)) are integrated. When processing one set of 32-bit data, the computing units (arithmetic logic-operation circuits (ALU1 and ALU2)) are integrated for operations.

When they (ALU1 and ALU2) are integrated, the condition data from ALU2 become valid. The integrating unit 12 selects the condition data from ALU2, and stores the condition data from ALU2 in the condition register 1. When a conditional command is subsequently issued, the selector 1 and the selector 2 select the condition data stored in the condition register 1, and the selected condition data are provided to the arithmetic logic-operation circuits (ALU1 and ALU2). Then, ALU1 and ALU2 determine whether an operation is to be carried out. In this way, the SIMD type microprocessor according to Embodiment 4 is capable of processing 32-bit data.

### Embodiment 5

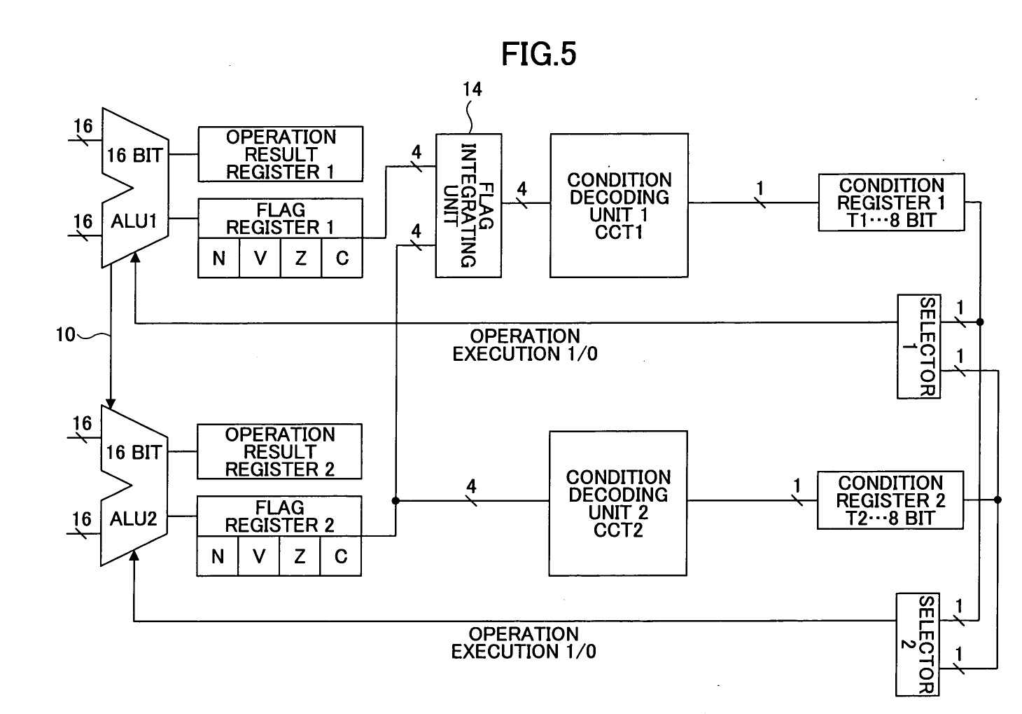

FIG. 5 is a block diagram of the PE (processor element) 4 of the SIMD type microprocessor 8 according to Embodiment 5 of the present invention. The PE, like Embodiment 2, includes the arithmetic logic-operation circuits (ALU1 and ALU2), the registers for storing operational results (the operation result register 1 and the operation result register 2), the condition registers (the condition register 1 and the condition register 2), the flag register groups (the flag register group 1 and the flag register group 2), and the condition decoding units (CCT1 and CCT2).

Furthermore, according to Embodiment 5, the PE is capable of operating with the computing units (arithmetic logic-operation circuits) integrated for processing. For this purpose, the PE includes a flag integrating unit 14 in addition to the selectors (the selector 1 and the selector 2), and the path 10.

The arithmetic logic-operation circuits (ALU1 and ALU2) carry out operations on 16-bit data that are input with a control signal from an external apparatus. The registers for storing operational results (the operation result register 1 and the operation result register 2) are capable of handling 16 bits for storing operational results of the arithmetic logic-operation circuits. Flag register groups (a flag register group 1 and a flag register group 2) are 4-bit registers, and hold flag data. The selectors (the selector 1 and the selector 2) select condition data provided by the condition register 1 and the condition register 2, and provide the selected condition data to the arithmetic logic-operation circuits (ALU1 and ALU2), respectively.

The path 10 is activated when the computing units (arithmetic logic-operation circuits (ALU1 and ALU2)) are integrated.

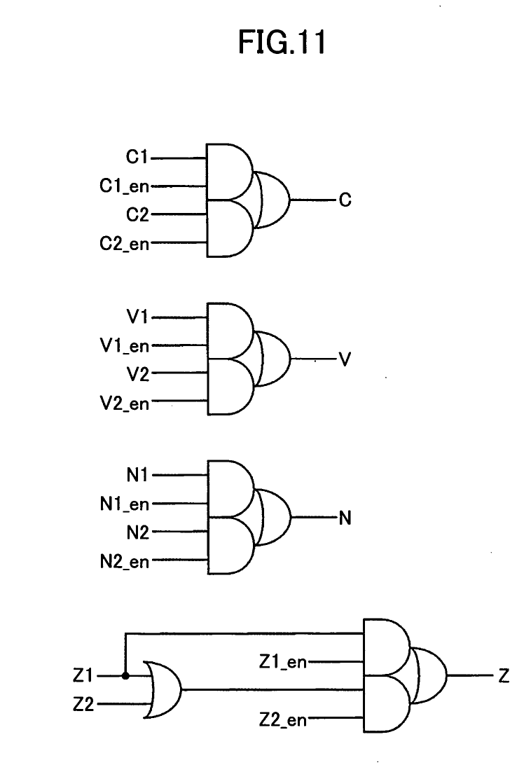

The flag integrating unit 14 is for selecting the flag data provided by the arithmetic logic-operation circuits (ALU1 and ALU2). FIG. 11 is a circuit diagram of the flag integrating unit 14. The flag integrating unit 14 includes a circuit for selecting between N1 and N2, a circuit for selecting between V1 and V2, a circuit for selecting between C1 and C2, and a circuit for selecting between Z1 of the flag register group 1 and an OR value of Z1 and Z2.

When processing one set of 32-bit data, the computing units (arithmetic logic-operation circuits (ALU1 and ALU2)) are integrated for operations.

When the computing units are integrated, the flag data of N2, V2, and C2 of the flag register group 2 become valid, are selected by the flag integrating unit 14, and are stored in the condition register 1. About the Z flag, an OR value of Z1 and Z2 is selected, and is stored in the condition register 1. When a conditional command follows, the selector 1 and the selector 2 select the condition data stored in the condition register 1, and provide the selected condition data to the arithmetic logic-operation circuits (ALU1 and ALU2), respectively. Then, whether ALU1 and ALU2 are to carry out the operation is determined. In this way, the SIMD type microprocessor 8 according to Embodiment 5 is capable of processing one set of 32-bit data.

According to the SIMD type microprocessor 8 according to Embodiment 5, when it is impossible to store the condition data in the condition register in one cycle from the arithmetic logic-operation circuit, it is possible to temporarily hold the flag data or condition data by the flag register groups (the flag register group 1 and the flag register group 2), and to provide them to the condition registers (the condition register 1 and the condition register 2) in the following cycle.

Furthermore, a great number of sets of complicated condition data can be generated by the condition decoding units (CCT1 and CCT2); in this way, the processing speed can be increased.

### Embodiment 6

The SIMD type microprocessor 8 according to Embodiments 6 through 10 includes a PE array that includes two or more PEs, wherein each PE includes M arithmetic logic-operation circuits (M is a natural number 2 or greater), M registers for storing operational results, and M condition registers. The PE includes an integrating unit for integrating N (2<=N<=M) computing units (arithmetic logic-operation circuits) for processing, and another unit for integrating N condition registers when N computing units are integrated.

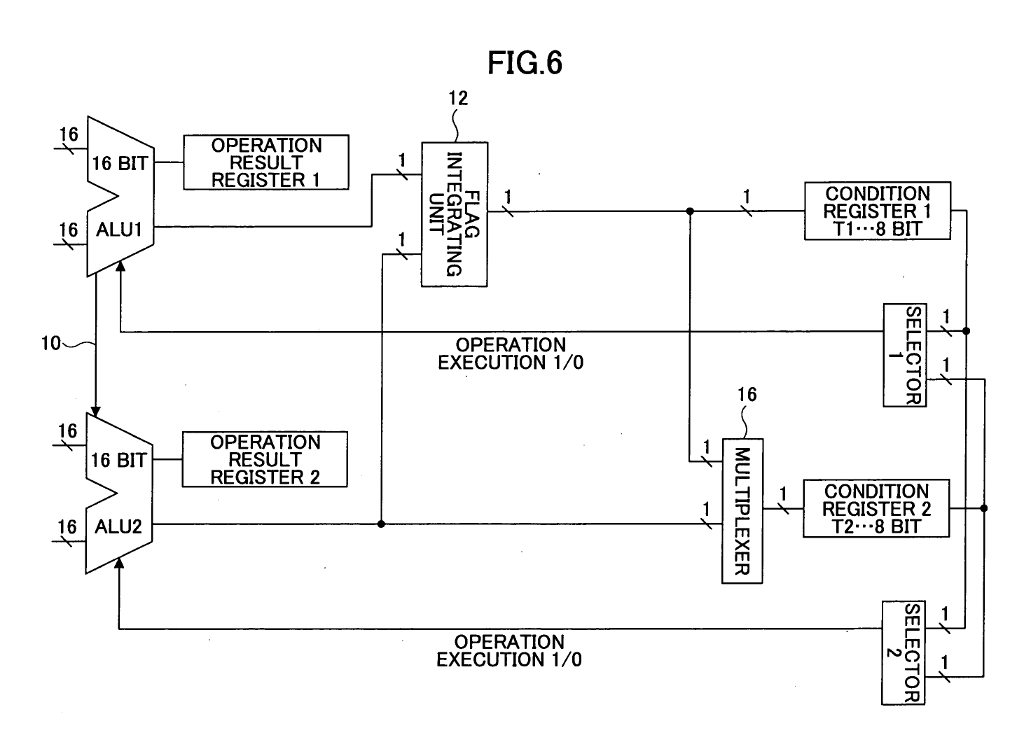

FIG. 6 is a block diagram of a part of the PE (processor element) 4 of the SIMD type microprocessor 8 according to Embodiment 6 of the present invention. Like Embodiment 4, the PE includes two arithmetic logic-operation circuits (ALU1 and ALU2), two registers for storing operational results (the operation result register 1 and the operation result register 2), and two condition registers (the condition register 1 and the condition register 2). The PE 4 further includes functional units for integrating the computing units (arithmetic logic-operation circuits) for processing. Namely, the PE includes the integrating unit 12, the selectors (the selector 1 and the selector 2), and the path 10.

Furthermore, in addition to the configuration of Embodiment 4 shown in FIG. 4, the PE 4 according to Embodiment 6 includes a multiplexer 16 just before the condition register 2.

According to the PE 4 of Embodiment 6, when processing 32-bit data, the computing units (arithmetic logic-operation circuits (ALU1 and ALU2)) are integrated for operations. When they are integrated, the condition data from ALU2 become valid, and can be selected by the integrating unit 12. Next, the condition data output from the integrating unit 12 are either stored in the condition register 1 or selected by the multiplexer 16 in front of the condition register 2 and stored in the condition register 2. Then, the condition data stored in the condition register 1 or the condition register 2, as applicable, are selected by the selector 1 and the selector 2; and the selected condition data are provided to the arithmetic logic-operation circuits (ALU1 and ALU2) so that the ALU1 and ALU2 may determine whether an operation is to be carried out at the following conditional command. That is, 16-bit conditions stored in the condition register 1 and the condition register 2 can be used when executing the conditional command. In other words, in comparison with Embodiment 4, twice the number of conditions can be used in the case of conditional command execution.

### Embodiment 7

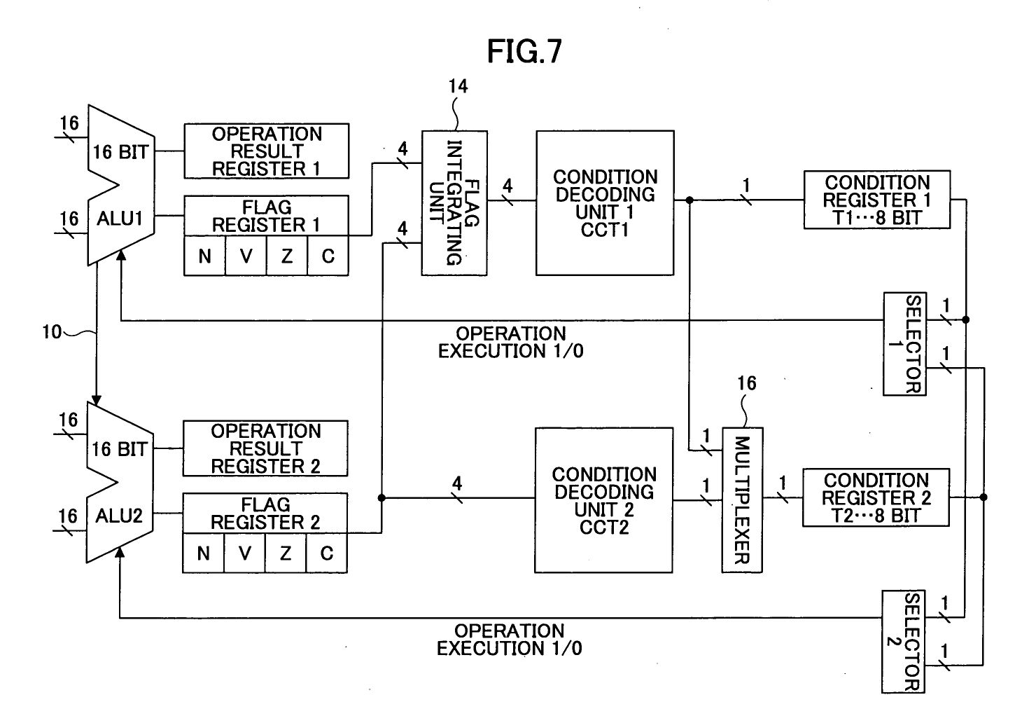

FIG. 7 is a block diagram of the PE (processor element) 4 of the SIMD type microprocessor 8 according to Embodiment 7 of the present invention. The PE 4, like Embodiment 5, includes two arithmetic logic-operation circuits (ALU1 and ALU2), two registers for storing operation results (the operation result register 1 and the operation result register 2), two condition registers (the condition register 1 and the condition register 2), two flag register groups (the flag register group 1 and the flag register group 2), two condition decoding units (CCT1 and CCT2), and the integrating unit for integrating the computing units (arithmetic logic-operation circuits) for processing. Namely, the PE 4 includes the selectors (the selector 1 and the selector 2), the flag integrating unit 14, and the path 10.

Furthermore, the PE 4 according to Embodiment 7 includes the multiplexer 16 just before the condition register 2, like Embodiment 6, in addition to the configuration of Embodiment 5.

According to the PE 4 of Embodiment 7, the two computing units (arithmetic logic-operation circuits (ALU1 and ALU2)) are integrated for processing 32-bit data. When they are integrated, the flag data from the flag register group 2 become valid, and can be selected by the flag integrating unit 14. Next, the condition data output from the CCT1 are either stored in the condition register 1, or selected by the multiplexer 16 in front of the condition register 2 and stored in the condition register 2. Then, at a conditional command that follows, the condition data stored in either the condition register 1 or the condition register 2 are selected by the selector 1 and the selector 2, and the selected condition data are provided to the arithmetic logic-operation circuits ALU1 and ALU2 such that whether the ALU1 and ALU2 are to carry out the operation may be determined. That is, 16-bit conditions stored in the condition register 1 and the condition register 2 are available at conditional command execution. In other words, in comparison with Embodiment 5, twice the number of conditions can be used in the case of conditional command execution.

Further, with the SIMD type microprocessor according to Embodiment 7, when it is impossible to store condition data from the arithmetic logic-operation circuit in the condition register in one cycle, it is possible to temporarily hold flag data or condition data in the flag register group (the flag register group 1 and the flag register group 2), and to provide them to the condition register (the condition register 1 and the condition register 2) in the following cycle.

Furthermore, a great number of sets of complicated condition data can be generated by the condition decoding units (CCT1 and CCT2), and the processing speed may be increased.

### Embodiment 8

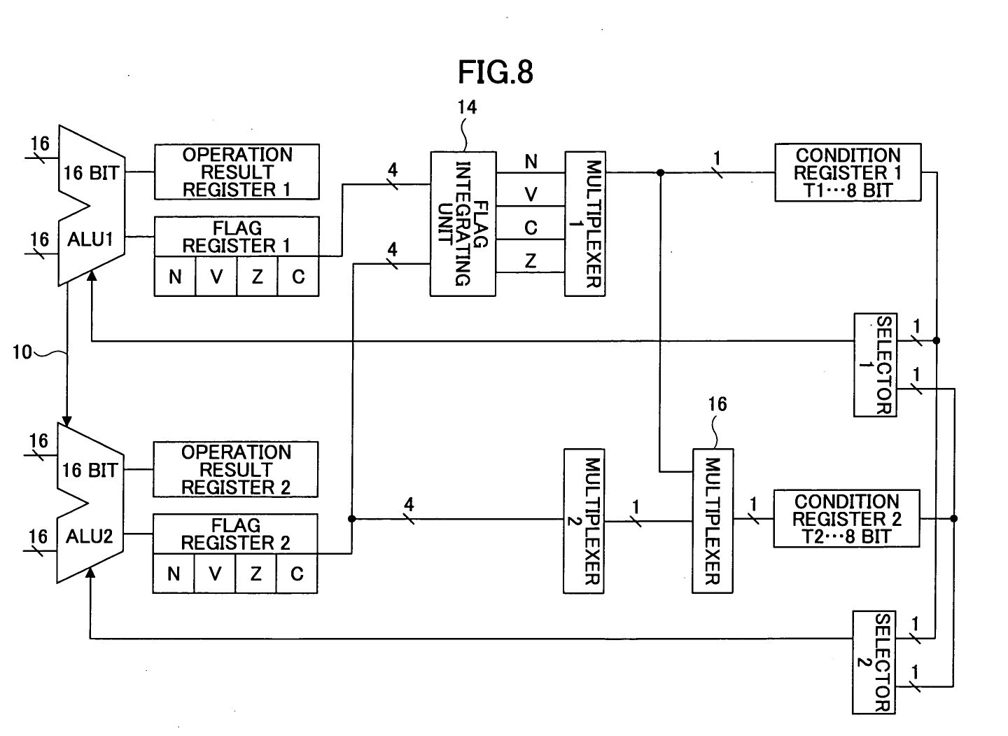

FIG. 8 is a block diagram of the PE (processor element) 4 of the SIMD type microprocessor 8 according to Embodiment 8 of the present invention. The SIMD type microprocessor 8 according to Embodiment 8 is almost the same as that of the SIMD type microprocessor 8 according to Embodiment 7.

Nevertheless, the PE 4 according to Embodiment 8 includes a multiplexer 1 and a multiplexer 2 instead of the condition decoding units (CCT1 and CCT2) included in the configuration according to Embodiment 7 shown in FIG. 7. The multiplexer 1 and the multiplexer 2 are usual multiplexer circuits.

When the flag data stored in the flag register groups (the flag register group 1 and the flag register group 2) are directly used as the condition data, the circuit of the condition decoding unit as shown in FIG. 11 is unnecessary. In addition, only the usual multiplexer circuit is sufficient. Since the usual multiplexer circuit is a small-scale circuit, the circuit of the PE shown in FIG. 8 can be simply structured compared with the circuit of the PE shown in FIG. 7.

### Embodiment 9

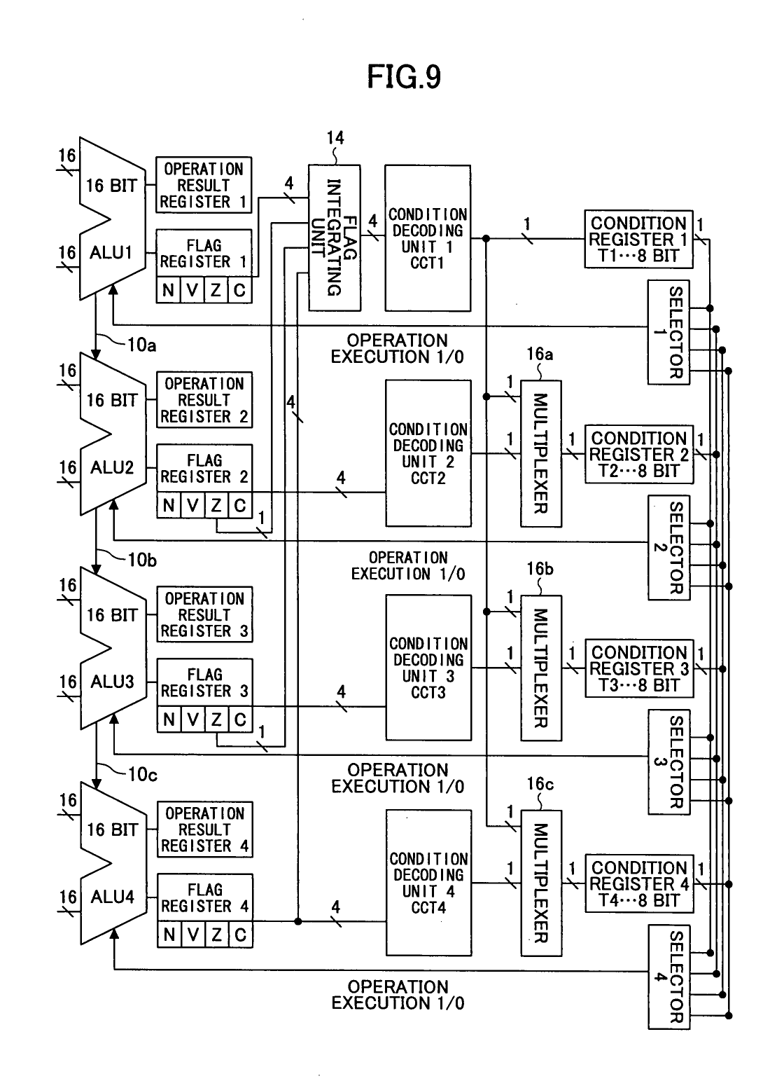

FIG. 9 is a block diagram of a part of the PE (processor element) 4 of the SIMD type microprocessor 8 according to Embodiment 9 of the present invention. Each of the PEs that constitute the SIMD type microprocessor according to Embodiment 9 includes four arithmetic logic-operation circuits (ALU1, ALU2, ALU3, and ALU4), four registers for storing operational results, and four condition registers. The PE further includes an integrating unit for integrating the four computing units (arithmetic logic-operation circuits) for processing, and another integrating unit for integrating the four condition registers when the four computing units are integrated.

Further, every PE includes four selectors (selector 1, selector 2, selector 3, and selector 4), four flag register groups (flag register group 1, flag register group 2, flag register group 3, and flag register group 4), and four condition decoding units (CCT1, CCT2, CCT3, and CCT4). Furthermore, the PE includes the flag integrating unit 14 just before the CCT1, and paths (10a, 10b, 10c) for propagating the carry from one arithmetic logic-operation circuit to the next one.

N1, V1, Z1 and C1 of the flag register group 1, Z2 of the flag register group 2, Z3 of the flag register group 3, and N4, V4, Z4, and C4 of the flag register group 4 are provided to the flag integrating unit 14 included in the PE according to Embodiment 9. The flag integrating unit 14 includes a circuit for selecting one of N, V, and C; and another circuit for selecting either an OR value of Z (i.e., Z1, Z2, Z3, Z4) or Z1 of the flag register group 1.

In the PE according to Embodiment 9, when processing one set of 64-bit data, one bit is selected out of the 32-bit condition data stored in the condition registers 1 through 4, and provided to the arithmetic logic-operation circuits (ALU1, ALU2, ALU3, and ALU4), respectively. The arithmetic logic-operation circuits (ALU1, ALU2, ALU3, and ALU4) determine based on the condition data whether to perform an operation when a conditional command is subsequently received.

Further, when processing four sets of 16-bit data, one bit is selected out of the 8-bit condition data stored in the condition registers 1 through 4, and provided to the arithmetic logic-operation circuits (ALU1, ALU2, ALU3, and ALU4), respectively. Then, the arithmetic logic-operation circuits (ALU1, ALU2, ALU3, and ALU4) determine whether to perform an operation when a conditional command is subsequently received based on the condition data.

According to the SIMD type microprocessor of Embodiment 9, a selection between operations of one set of 64-bit data and four sets of 16-bit data is provided.

### Embodiment 10

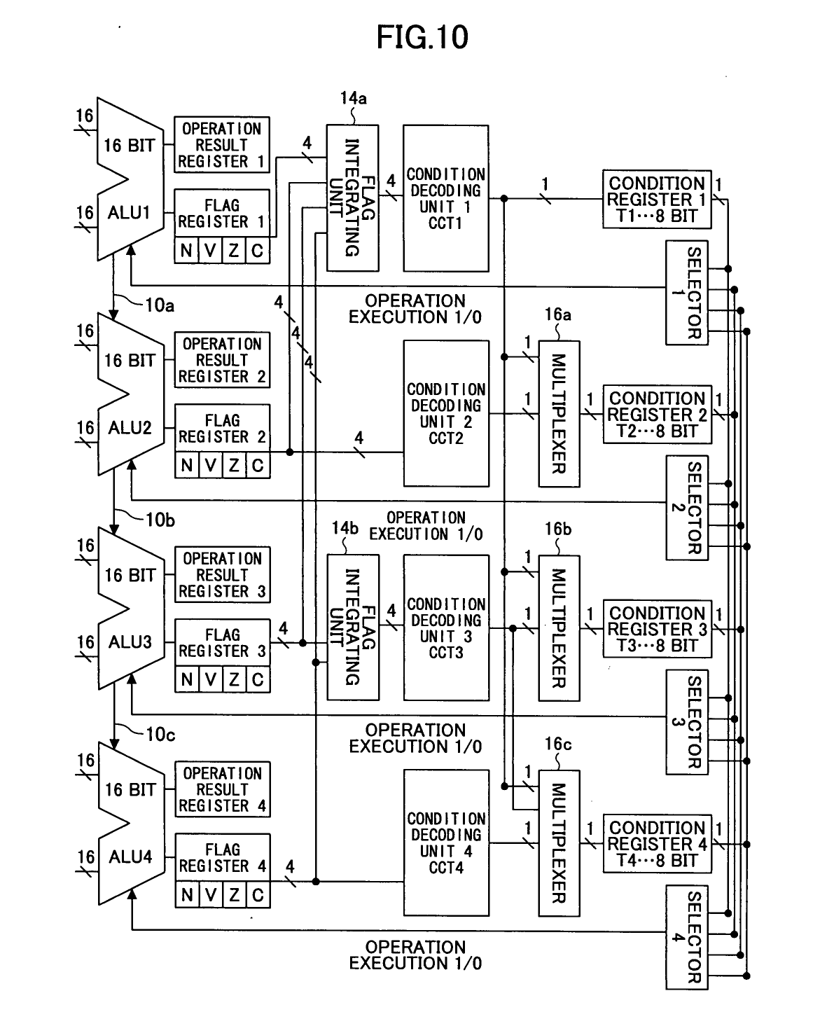

FIG. 10 is a block diagram of the PE (processor element) 4 of the SIMD type microprocessor 8 according to Embodiment 10 of the present invention. The SIMD type microprocessor 8 according to Embodiment 10 is almost the same as that of the SIMD type microprocessor 8 according to Embodiment 9.

However, in the PE 4 according to Embodiment 10, two computing units (arithmetic logic-operation circuit) are integrated, and two condition registers are integrated. Specifically, the PE 4 according to Embodiment 10 includes a flag integrating unit 14a just before the condition decoding unit 1, and a flag integrating unit 14b just before the condition decoding unit 3.

The flag integrating units (14a and 14b) are configured to correspond to an input.

According to the PE 4 of Embodiment 10, when processing one set of 64-bit data, one bit is selected out of the 32-bit condition data stored in the condition registers 1 through 4, and provided to the arithmetic logic operation circuits (ALU1, ALU2, ALU3, and ALU4), respectively. The arithmetic logic-operation circuits (ALU1, ALU2, ALU3, and ALU4) determine based on the condition data whether to perform an operation when a conditional command is subsequently received.

Further, when processing two sets of 32-bit data, one bit is selected from the 16-bit condition data stored in the condition registers 1 and 2, and provided to the ALU1 and ALU2, respectively. The ALU1 and ALU2 determine based on the condition data whether to perform an operation when a conditional command is subsequently received. Similarly, one bit is selected out of the 16-bit condition data stored in the condition registers 3 and 4, and provided to the ALU3 and ALU4, respectively. The ALU3 and ALU4 determine based on the condition data whether to perform an operation when a conditional command is subsequently received.

Furthermore, when processing four sets of 16-bit data, one bit is selected from the 8-bit condition data stored in the condition registers 1 through 4, and provided to the arithmetic logic-operation circuits (ALU1, ALU2, ALU3, and ALU4), respectively. The arithmetic logic-operation circuits (ALU1, ALU2, ALU3, and ALU4) determine based on the condition data whether to perform an operation when a conditional command is subsequently received.

According to the SIMD type microprocessor 8 of Embodiment 10, selections are possible out of operations of one set of 64-bit data, two sets of 32-bit data, and four sets of 16-bit data.

Further, the present invention is not limited to these embodiments, but variations and modifications may be made without departing from the scope of the present invention.

The present application is based on Japanese Priority Application No. 2006-249375 filed on Sep. 14, 2006 with the Japanese Patent Office, the entire contents of that are hereby incorporated by reference.

What is claimed is:

1. A SIMD type microprocessor comprising:
a processor element array that is constituted by a plurality of processor elements;
M arithmetic logic-operation circuits (M is a natural number 2 or greater) included in each processor element;
M registers for storing operational results corresponding to the arithmetic logic-operation circuits included in each processor element; and
M condition registers included in each processor element for storing condition data provided by the corresponding arithmetic logic-operation circuits; wherein
whether each of the arithmetic logic-operation circuits is to perform an operation of a conditional command is determined based on the condition data stored in the corresponding condition registers.

2. The SIMD type microprocessor as claimed in claim 1, further comprising:
an integrating unit corresponding to each processor element for integrating N arithmetic logic-operation circuits (2<=N<=M); wherein
the N arithmetic logic-operation circuits are integrated by the integrating unit, the condition data generated by the N arithmetic logic-operation circuits are integrated, the integrated condition data are stored in one of the N condition registers corresponding to the N arithmetic logic-operation circuits, and whether the integrated arithmetic logic-operation circuits are to perform an operation when a conditional command is received is determined based on the condition data stored in the condition register.

3. The SIMD type microprocessor as claimed in claim 2, wherein
when the N arithmetic logic-operation circuits (2<=N<=M) of each processor element are integrated, the N condition registers are integrated.
